(19) United States
(12) Patent Application Publication
(10) Pub. No.: US 2012/0313950 A1
(43) Pub. Date: Dec. 13, 2012

(54) Texting system

(76) Inventor: Adam A. Ochoa, Scottsdale, AZ (US)

(21) Appl. No.: 13/385,971

(22) Filed: Mar. 16, 2012

Related U.S. Application Data
(60) Provisional application No. 61/465,406, filed on Mar. 18, 2011.

(51) Int. Cl. G06T 11/00

(52) U.S. Cl. 345/467

(57) ABSTRACT

A texting system includes a computer. The computer includes a display screen, a microprocessor, and a memory. A conventional alphanumeric keyboard is operatively associated with the computer to generate commands to the computer. A chart includes abbreviations each corresponding to a particular descriptor in a selected language. A texting keyboard is operatively associated with the computer and includes a plurality of keys, each key including at least one of said abbreviations inscribed thereon, and when activated generating a signal causing the computer to produce one of the abbreviations on the display screen. A system generates communication signals corresponding to keys on the texting keyboard which are activated to produce a message comprised of at least one descriptor.

This application claims priority based on provisional patent application Ser. No. 61/465,406, filed Mar. 18, 2011.

This invention relates to communication systems.

Those of skill in the art have for many years endeavored to provide improved communication systems.

Accordingly, it would be highly desirable to provide an improved communication system.

Therefore, it is an object of the instant invention to provide an improved communication system.

This and other, further and more specific objects and advantages of the invention will be apparent to those skilled in the art from the following detailed description thereof, taken in conjunction with the drawings, in which:

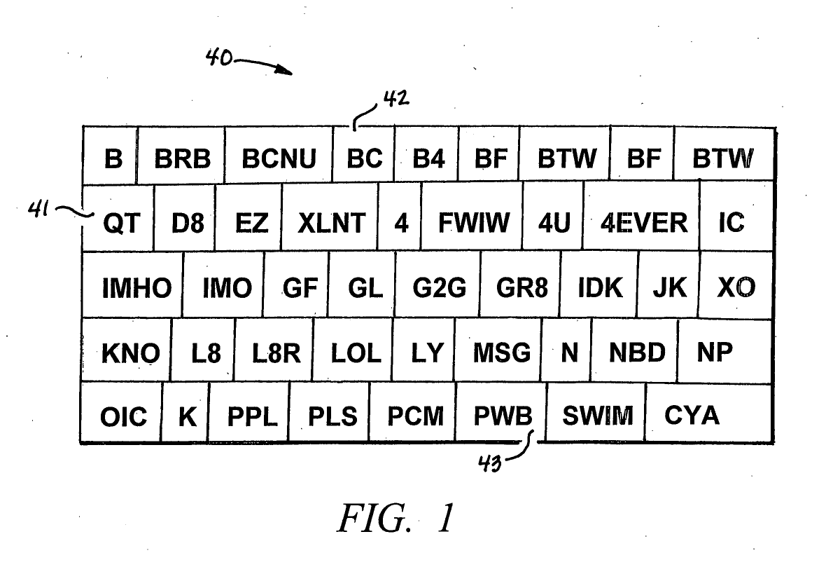

FIG. 1 is a top view illustrating a texting keyboard utilized in one embodiment of the invention;

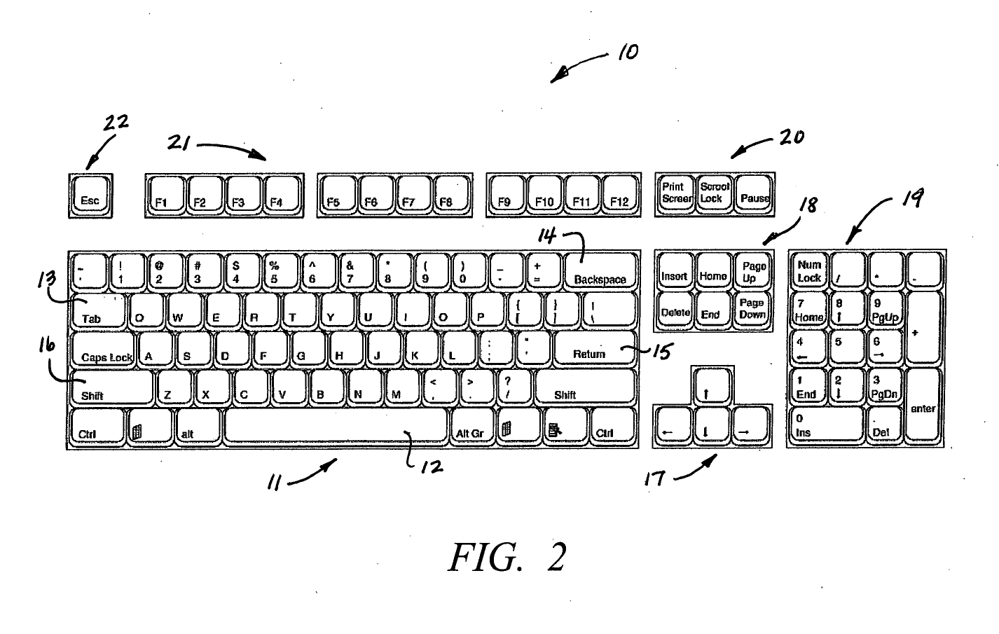

FIG. 2 is a top view illustrating a conventional alphanumeric keyboard; and,

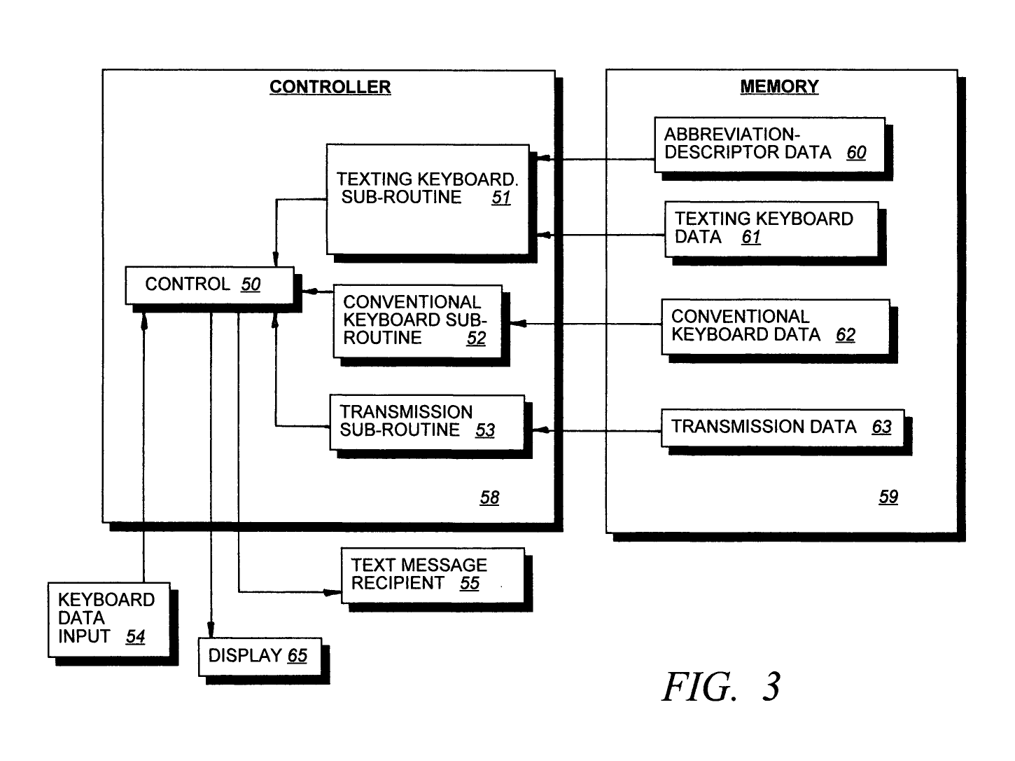

FIG. 3 is a block diagram illustrating a texting system constructed in accordance with the principles of the invention.

Briefly, in accordance with the invention, I provide an improved texting system. The texting system includes a computer including a display screen, a microprocessor, and a memory; includes a conventional alphanumeric keyboard operatively associated with the computer to generate commands to the computer; includes a chart of abbreviations each corresponding to a particular descriptor in a selected language; and, includes a texting keyboard operatively associated with the computer and including a plurality of keys. Each key includes at least one of said abbreviation inscribed thereon; and, when activated generates a signal causing the computer to produce one of the abbreviations on the display screen. The texting system also includes a system to generate communication signals corresponding to keys on the texting keyboard which are activated to produce a message comprised of at least one descriptor; and, includes a transmitter system to send the communication signals to a selected recipient.

Turning now to the drawings which illustrate the invention by way of example and not by way of limitation of the scope of the invention, and in which like reference characters refer to corresponding elements throughout the several views, FIG. 2 illustrates a conventional alphanumeric computer keyboard generally indicated by reference character 10 and including a first primary portion 11 comprising a first primary portion of the type typically found on older manual typewriters. Primary portion 11 includes basic keys including keys for typing letters of the alphabet and numerals 1, 2, 3, 4, 5, 6, 7, 8, 9, 0 along with a space bar 12, a tab key 13, a backspace key 14, a return key 15, and at least one shift key 16. A conventional alphanumeric computer keyboard can, if desired, include only selected ones of the basic keys, but typically includes at least all of the basic keys. The keyboard 10 also includes a group 17 of keys to move up, down, left or gift on a computer display screen; includes a group 18 of keys to page up, page down, and carry out other commands; includes a group 19 of keys that can function as a mathematical calculator and carry out other functions; includes a group 20 of keys for printing, scrolling, and pausing; includes a group 21 of function keys F1 to F12; and, includes an escape key 22.

Keyboard 10 is operatively associated with a computer. The computer typically includes, in conventional fashion, a microprocessor 58, a memory 59, and a display screen 55 (FIG. 3). One conventional form of such a computer is a desktop computer. Another conventional form of such a computer is a portable laptop computer. A further conventional form of such a computer is a portable, hand held cellular telephone. Still another conventional form of such a computer is a portable iPad. As is well known, when a key on keyboard 10 is depressed, the alphanumeric character or symbol on the key ordinarily appears on the display screen 55, or, in the event the key is associated with a function like “Caps Lock”, “Shift”, or “Tab”, the particular function is performed by the computer.

FIG. 1 illustrates a texting keyboard 40 constructed in accordance with the invention and including a plurality of keys 41, 42, 43 each labeled with an abbreviation generated in accordance with the invention. Each abbreviation is a shortened form of a descriptor. The abbreviation can utilize numerals, letters, or other symbols. Table 1 below identifies descriptors associated with abbreviations which appear on the keys illustrated in FIG. 1. In FIG. 1, each key 41, 42, 43 has a single abbreviation printed on the key. If desired, two different abbreviations can be imprinted on each key in the manner of the keys in FIG. 2 which bear both a numeral (1, 2, 3 . . . etc.) and a symbol (?, @, # . . . etc.) on the keys. When a key in keyboard 40 bears two abbreviations, the keyboard 40 is operable to produce one or the other abbreviation in the same manner that the numeral keys in FIG. 2 are operable to produce one or the other of the numerals and symbols on the numeral keys, i.e., a shift key normally is utilized to utilize the symbols on the top of the keys. As is normally the case during the operation of keyboard 10 to compose a written message or document, in most instances only a single key 41, 42, 43 is depressed at any given time.

As would be appreciated by those of skill in the art, the particular descriptors selected and the particular abbreviation selected to correlate with a particular descriptor can vary as desired. The selected descriptors can, for example, include at least in part jargon or expressions common to a particular person or to a particular segment of the population. The descriptors and abbreviations set forth in Table 1 are provided by way of example and not limitation.

TABLE 1
Descriptors and Associated Abbreviations

| DESCRIPTOR | ABBREVIATION |
|---|---|
| Be | B |
| Be right back | BRB |
| Be seeing you | BC |
| Before | B4 |
| Best friend forever | BFF |
| Boyfriend | BF |
| By the way | BTW |
| Cutie | QT |
| Date | D8 |
| Easy | EZ |
| Excellent | XLNT |
| For | 4 |
| For what it's worth | FWIW |
| For you | 4U |
| Forever | 4EVER |
| I see | IC |
| In my humble opinion | IMHO |
| In my opinion | IMO |
| Girlfriend | GF |
| Good luck | GL |
| Got to go | G2G |
| Great | GR8 |
| I don't know | IDK |
| Just kidding | JK |
| Kiss and hug | XO |
| Know | KNO |
| Late | L8 |
| Later | L8R |
| Laughing out loud | LOL |
| Love you | LY |
| Message | MSG |
| No | N |
| No big deal | NBD |
| No problem | NP |
| Oh, I see | OIC |
| Okay | K |
| People | PPL |
| Please | PLS |
| Please call me | PCM |
| Please write back | PWB |
| See what I mean | SWIM |
| See ya | CYA |

A descriptor can also comprise a drawing (for example a smiley face), illustration, photograph, or other symbol(s).

The conventional keyboard 10 and the texting keyboard 40 can each comprise a separate physical apparatus which is constructed from plastic or other material and which is connected to the computer, either by hard wiring or by wi-fi or another wireless transmission system. Or, one of the conventional keyboard 10 and the texting keyboard 40 can comprise a separate physical apparatus which is constructed from plastic or other material while the other keyboard comprises a touch keyboard which appears on the computer display screen or on another display screen utilized in conjunction with the computer. Some handheld mobile telephones (for example a Blackberry™ include as an integral part of the telephone a physical keyboard constructed of plastic or other material in combination with a display screen. In such mobile phones the texting keyboard can appear on the display screen. If desired, a computer can utilize only a texting keyboard and not utilize a conventional keyboard.

In the presently preferred embodiment of the invention, however, each keyboard comprises a keyboard which selectively appears on a touch screen, preferably the primary display screen, associated with a computer. In particular, in the presently preferred embodiment of the invention, both the conventional keyboard and the texting keyboard appear on the display screen of a cellular or other mobile phone or electronic apparatus which is utilized for sending text messages between mobile phone owners. Typically, only one keyboard, either the conventional alphanumeric keyboard 10 or the texting keyboard 40, appears on the mobile telephone display screen at any given time. It is; of course, possible for both keyboards to appear simultaneously on a display screen, particularly if the screen is significantly larger than the screen on a typical mobile phone.

Indexing or switching between the conventional alphanumeric keyboard and the texting keyboard (or simply selected one of the keyboards) can be accomplished in any desired manner. There typically is a first control key or button which appears on the display screen or is at some other location on the mobile phone or other electronic computer device utilized in the invention. When the first control key or button is depressed or otherwise operated, the texting keyboard 40 (or the alphanumeric keyboard 10) appears on the display screen of the mobile phone. When the first control key is pressed again (or some other control key is pressed or otherwise activated), then the texting keyboard disappears from the display screen and the conventional alphanumeric keyboard appears on the display screen. The keyboard, whether it be the conventional alphanumeric keyboard 10 or the texting keyboard 40, typically in conventional fashion only occupies a portion of the display screen such that messages or other material prepared by typing on the key board can appear on the remaining portion of the display screen and be viewed by a user.

As noted, the texting keyboard comprises a plurality of keys. Each key is associated with a separate one of the abbreviations in Table 1 or with a separate one of other selected abbreviations.

By way of example, the texting keyboard 40 can be utilized by a user to prepare a message by depressing in sequence the BRB (be right back), the space button, and BFF (best friend forever) keys. The abbreviation BRB appears on a portion of the computer display screen followed by a space. The space is followed by the abbreviation BFF. The text message is transmitted in conventional fashion by calling up a “send” button (if the “send” button is not already displayed on the screen), and pressing the touch display screen directly over the “send” button. The mobile phone includes, in conventional fashion, a system for generating control signals containing data representing the text message, and, also includes a system to transmit the control signals to a selected recipient. The transmission can be via satellite, cell phone towers, etc. The recipient typically is selected by a user before the text message is composed, but can, if desired, be selected after the text message is composed. The recipient ordinarily is identified on the user's mobile telephone by name and telephone number, but can be identified by any other means which will insure the text message will be transmitted to a computer owned and/or operated by the intended recipient or by a representative appointed by the recipient. The recipient's name and telephone number ordinarily is in a directory previously stored in the memory of the mobile telephone, but can, of course, be entered in the mobile telephone by the user just prior to transmitting a text message to the recipient.

Software integrated in mobile phones or other computer systems to generate a data base consisting of names, telephone numbers, or other data identifying a recipient are well known in the art and are not discussed in detail herein. The practical use of such data bases by mobile phone owners/users to compose and transmit text messages is also well known in the art.

In one embodiment of the invention, when a texting keyboard is prepared, the layout of keys illustrated in FIG. 2 (or any other desired layout of keys) is utilized and abbreviations from Table 1 are, in addition to being utilized on keys in primary portion 11, used on keys in group 17, 18, 19, 20, or 21 or on the escape key 22. This provides a greater assortment of keys on which abbreviations from Table 1 can be utilized. A particular group 17 to 21, portion 11, or key 22 may, if desired, consist of abbreviations related to a common topic or common included word or other characteristic which creates a relationship or similarity between the descriptors represented by the abbreviations. For example, the abbreviations on particular group of keys could each pertain to terms of endearment like love, friendship, admiration, etc. Or, the abbreviations on a particular group of keys can comprise the favorite expressions utilized by a user.

In one embodiment of the invention, if a key in a particular grouping of keys (say a group of keys comprised of favorites) is pressed and held, then a specialized keyboard of all favorite abbreviations appears. Such a specialized keyboard can include more favorite keys than the limited number of favorite keys in the particular group 17 to 21, 11 or 22.

In another embodiment of the invention, portions of a conventional alphanumeric keyboard 10 are combined in a single display with portions of a texting keyboard.

In a further embodiment of the invention, portions of a conventional alphanumeric keyboard can be programmed to appear as texting keys. For example, the F1 function key can be programmed to appear on the display screen as a key with the symbl “LOL” on the key instead of the symbol F1; and, when the F1 key is then pressed, the letters “LOL” appear in a portion of the display screen as comprising a portion of a text message which is being composed.

The texting system of FIG. 3 comprises a computer including controller (microprocessor) 58, a memory 59, and a display screen 65. Keyboards are operatively associated with the computer to input 54 data into the controller 58 and memory 59. Memory 59 includes abbreviation-descriptor data 60, texting keyboard data 61 utilized in operating a texting keyboard 40, conventional key board data 62 utilized in operating a conventional keyboard, and transmission data 63 utilized in sending and receiving text messages. Controller 50 includes control 50, texting keyboard sub-routine 51 utilized in the operation of the texting keyboard, conventional keyboard sub-routine 52 utilized in the operation of the conventional keyboard, and transmission sub-routine 53 utilized in transmitting and receiving text messages. The texting keyboard can appear on display 65 and be operated utilizing a conventional keyboard, or, if the display comprises a touch screen, the texting keyboard can, when it appears on the touch screen, be operated in conventional fashion by touching, or gently pressing, the touch screen at points directly over the keyboard keys desired to be selected and operated. Similarly, if the display comprises a touch screen, the conventional keyboard can, when it appears on the touch screen, be operated in conventional fashion by touching, or gently pressing, the touch screen at points directly above the keyboard keys desired to be selected and operated.

In another embodiment of the invention, operation of the keyboard is voice controlled and a user says “depress key LOL” or utilizes some other verbal command to selected a particular keyboard key. After a text message is composed using either a conventional keyboard 10 or a texting keyboard 40, the user enters the appropriate command in controller 58 such that control 50 transmits the text message to the text message recipient 55.

In an alternate embodiment of the invention, the user composes a text message and encrypts the text message. The message is encrypted by sending the text message with a selected descriptor(s) or abbreviation(s). For example, the text message may be “Meet me at the ballpark at 7:00 pm”. The descriptors for the text message may be “Baseball game tonight.”. When the recipient receives the text message, the descriptors “Baseball game tonight.” appears on the recipient's display screen. The recipient then knows that an encrypted message is attached. The recipient enters the appropriate commands in his computer to open and read the encrypted message, i.e., to read “Meet me at the ballpark at 7:00 pm”. The command necessary to open and read the encrypted message can be selected as desired and can be preprogrammed into the computer, or, can be selected and programmed into the computer after the user purchases the computer or purchases a computer program (“an app”) to be used on the computer.

The language utilized in preparing a conventional alphanumeric keyboard 10 or texting keyboard 40 can vary as desired, with English being the presently preferred language in the United States. French, German, Spanish, Italian or any other language can, however, be utilized.

Having described my invention in such terms as to enable those skilled in the art to understand and practice the invention, and having described various embodiments thereof,

I claim:

1. A texting system including
(a) a computer including
(i) a display screen,
(ii) a microprocessor, and
(iii) a memory;
(b) a conventional alphanumeric keyboard operatively associated with said computer to generate commands to said computer;
(c) a chart of abbreviations each corresponding to a particular descriptor in a selected language;
(d) a texting keyboard operatively associated with said computer and including a plurality of keys, each key
(i) including at least one of said abbreviations inscribed thereon, and
(ii) when activated generating a signal causing said computer to produce one of said abbreviations on said display screen;
(e) a system to generate communication signals corresponding to keys on said texting keyboard which are activated to produce a message comprised of at least one descriptor; and.
(f) a transmitter system to send said communication signals to a selected recipient.
